(19) United States
(12) Patent Application Publication
(10) Pub. No.: US 2025/0349069 A1
(43) Pub. Date: Nov. 13, 2025

(54) VIDEO TO EVENT SIMULATION METHODS AND SYSTEMS

(71) Applicant: THE REGENTS OF THE UNIVERSITY OF CALIFORNIA, Oakland, CA (US)

(72) Inventors: Zhongyang Zhang, San Diego, CA (US); Tauhidur Rahman, San Diego, CA (US); Shuyang Cui, La Jolla, CA (US)

(21) Appl. No.: 18/407,688

(22) Filed: May 9, 2024

(51) Int. Cl. G06T 17/00; G06T 7/70; G06V 10/60

(52) U.S. Cl. CPC G06T 17/00; G06T 7/70; G06V 10/60; G06T 2207/20044; G06T 2207/30196

(57) ABSTRACT

A video to event prediction pipeline system includes a backbone conversion network having a model that is configured to receive a raw active pixel sensor video sequence and convert it into 3D predicted voxels. An event sampling module is configured to receive the 3D predicted voxels and create event timestamps in a continuous scale by leveraging nonlinear dynamics of event firing trends in each voxel of the 3D predicted voxels. The backbone conversion network comprises a series of training loss function modules, the training loss function modules teaching the backbone conversion network to account for variations in the active pixel sensor video sequence caused by adjustable camera parameters of the active pixel sensor video sequence.

### FIELD

A field of the invention is video processing. The invention is applicable, for example, to enhance traditional image sensor video, to animations, and to systems that include event-based sensors, such as neuromorphic vision systems. Example applications include vision systems, such as for robots or vehicles, gaming systems, including console and virtual reality, virtual reality generally, low light and high contrast image processing, and ultra-high speed image generation or analysis.

### BACKGROUND

Images frames in video are typically obtained by standard cameras that use an active pixel sensor Active Pixel Sensor (APS), A standard RGB camera in a mobile device or a camera body includes an APS. Some cameras are enhanced by a depth sensor, which can provide additional information. Vision systems can include an RGB camera and a depth sensor, which could be image or another technology, such as RADAR. Cameras that use APS sensors typically produce about 30 frames per second (fps) of data, which will fail to capture high speed non-linear motion of different high speed objects. Very high frame rate cameras exist that can deliver 1000, 10,000 fps or more, but these camera bodies tend to be very expensive and are unsuitable for many common applications.

Neuromorphic cameras, also referred to as Dynamic Vision Sensors (DVS) or event cameras limit data acquisition to changes in pixel intensity, which permits very high-speed event tracking and also performs well in very bright or very dark scenes where traditional APS sensor cameras perform poorly. These types of cameras have recently emerged as a significant area of interest in the field of robotics and computer vision. See, Sandamirskaya, et al., “Neuromorphic computing hardware and neural architectures for robotics,” Science Robotics, vol. 7, no. 67, (2022); Zhu, et al., “Event-based feature tracking with probabilistic data association,” in 2017 IEEE International Conference on Robotics and Automation (ICRA). pp. 4465-4470 (2017); Li and Stueckler, “Tracking 6-dof object motion from events and frames,” in 2021 IEEE International Conference on Robotics and Automation (ICRA), pp. 14171-14177 (2021); Gehrig and Scaramuzza, “Recurrent vision transformers for object detection with event cameras,” in Proceedings of the IEEE/CVF Conference on Computer Vision and Pattern Recognition, pp. 13884-13893 (2023); Chamorro, et al., “Event-imu fusion strategies for faster-than-imu estimation throughput,” in Proceedings of the IEEE/CVF Conference on Computer Vision and Pattern Recognition, pp. 3975-3982 (2023); Baby, et al., “Dynamic vision sensors for human activity recognition,” in 2017 4th IAPR Asian Conference on Pattern Recognition (ACPR). IEEE online, (2017).

Event based sensing provides exceptionally high optical event capture rate, high dynamic range, low yet adaptive power consumption, sparse output, and a dynamic vision scheme akin to mammalian perception. These event based sensing approaches tend to offer superior temporal resolution and quicker inference speeds than traditional based image sensor systems.

This is useful in computer vision applications that conduct pattern analysis and use machine intelligence to detect objects, people, and animals. See, M. Gehrig, et al., “Dsec: A stereo event camera dataset for driving scenarios,” IEEE Robotics and Automation Letters, vol. 6, pp. 4947-4954, (2021); Rebecq, R. et al., “High speed and high dynamic range video with an event camera,” IEEE Transactions on Pattern Analysis and Machine Intelligence, vol. 43, pp. 1964-1980 (2019); Mahlknecht, et al., “Exploring event camera-based odometry for planetary robots,” IEEE Robotics and Automation Letters, vol. 7, pp. 8651-8658 (2022).

Particular functions of event-based sensing systems are varied. An example function is feature tracking. See, Seok Lim, “Robust feature tracking in dvs event stream using bézier mapping,” 2020 IEEE Winter Conference on Applications of Computer Vision (WACV), pp. 1647-1656 (2020); Dong and Zhang, “Standard and event cameras fusion for feature tracking,” Proceedings of the 2021 International Conference on Machine Vision and Applications (2021); Pan, et al., “Single image optical flow estimation with an event camera,” 2020 IEEE/CVF Conference on Computer Vision and Pattern Recognition (CVPR), pp. 1669-1678 (2020).

Another application is optical flow estimation. Optical flow estimation is a computer vision task that involves computing the motion of objects, people or animals in an image or a video sequence. See, Bardow, et al, “Simultaneous optical flow and intensity estimation from an event camera,” 2016 IEEE Conference on Computer Vision and Pattern Recognition (CVPR), pp. 884-892 (2016); Bardow et al., “Simultaneous optical flow and intensity estimation from an event camera,” 2016 IEEE Conference on Computer Vision and Pattern Recognition (CVPR), pp. 884-892 (2016).

Another application is pose and gesture estimation. Animate objects, such as animals (including persons) and robots that change pose can have their movements estimated using event-based data or through event simulation. See, Calabrese, et al, “DHP19: Dynamic vision sensor 3d human pose dataset,” 2019 IEEE/CVF Conference on Computer Vision and Pattern Recognition Workshops (CVPRW),” pp. 1695-1704 (2019).

While event-based processing and cameras provide advantages, labeling the data is difficult because events captured are sparse and inactive objects trigger few events. There is a scarcity of large-scale annotated DVS datasets. Dataset collection typically proves to be time-consuming and expensive, and it is neither practical nor cost-effective to recreate every existing APS dataset for DVS.

There are a few existing works trying to bridge the gap between the APS frames and events. See, e.g., Rebecq, et al, “Esim: an open event camera simulator,” in Proceedings of The 2nd Conference on Robot Learning, ser. Proceedings of Machine Learning Research, A. Billard, A. Dragan, J. Peters, and J. Morimoto, Eds., vol. 87. PMLR, 29-31 pp. 969-982 (2018); Gehrig, et al., “Video to events: Recycling video datasets for event cameras,” in IEEE Conf. Comput. Vis. Pattern Recog. (CVPR) (2020); Hu, et al., “v2e: From video frames to realistic DVS events,” in 2021 IEEE/CVF Conference on Computer Vision and Pattern Recognition Workshops (CVPRW) (2021); Jiang, et al, “Eventbased low-illumination image enhancement,” IEEE Transactions on Multimedia, pp. 1-12, 2023; Liu, et al., “Low-light video enhancement with synthetic event guidance,” 2022.

These methods can be roughly divided into two genres: rule-based and model-based. The rule-based approaches don't recover the lost information due to the dynamic range gap between standard APS and DVS. The model-based approaches neglects characteristics differences between APS and DVS cameras.

These past approaches fail to recognize or address what is identified by the present inventors as the last mile problem: how to convert generated event voxels or the events number into realistic and accurate raw event streams. The prior methods directly apply either random or even sampling, which is suboptimal.

Another drawback of the prior methods is that events produced by the methods continue to reside in a series of discrete temporal layers. A 3D visualization of ground truth events and generated events would show that the generated events share a series of discrete timestamps, instead of spreading across the time axis in a continuous fashion like real DVS recordings. This discrepancy is often negligible when temporal accumulation-based methods are utilized in subsequent task preprocessing, as the temporal information is collapsed anyway. However, for tasks that are sensitive to timestamps distribution, such as Graph Neural Network (GNN) and Spiking Neural Network (SNN) this issue could prohibit using generated synthetic data as pretraining dataset, since these data has a significant domain shift compared to real events. See, e.g., Scarselli, et al, “The graph neural network model,” IEEE Transactions on Neural Networks, vol. 20, pp. 61-80 (2009). Schaefer, et al, “Aegnn: Asynchronous event-based graph neural networks,” (2022); Sun et al, “Event-based object detection using graph neural networks,” in 2023 IEEE 12th Data Driven Control and Learning Systems Conference (DDCLS), pp. 1895-1900 (2023); Tavanaei, et al, “Deep learning in spiking neural networks,” Neural networks: the official journal of the International Neural Network Society, vol. 111, pp. 47-63 (2018); Deng, et al, “Temporal efficient training of spiking neural network via gradient re-weighting,” ArXiv, vol. abs/2202.11946 (2022); Cordone, et al, “Learning from even cameras with sparse spiking convolutional neural networks,” (2021); Zhu, et al., “Event-based video reconstruction via potential-assisted spiking neural network,” (2022); Zhu, et al, “The multivehicle stereo event camera dataset: An event camera dataset for 3d perception,” IEEE Robotics and Automation Letters, vol. 3, no. 3, pp. 2032-2039 (2018).

A particular challenge for event-based cameras is pose estimation, such as human dance pose estimation. TORE attempts to mimic the human retina by preserving the membrane's potential properties. See, Baldwin, et al, “Time-ordered recent event (tore) volumes for event cameras,” ArXiv abs/2103.06108 (2021).

In TORE, a fixed-length (e.g., K) First-In-First-Out (FIFO) queue is adopted to record the relative timestamp of the most recent K events. When a new event enters a pixel's queue, its relative timestamp is inserted, and the oldest event in the queue is expelled. TORE calculates the logarithm of these timestamps in the FIFO buffer. TORE transforms the sparse event stream into a dense, bio-inspired representation with minimal information loss, achieving state-of-the-art results in various DVS tasks (e.g., classification, denoising, human pose estimation).

### SUMMARY OF THE INVENTION

A preferred embodiment provides a video to event prediction pipeline system includes a backbone conversion network having a model that is configured to receive a raw active pixel sensor video sequence and convert it into 3D predicted voxels. An event sampling module is configured to receive the 3D predicted voxels and create event timestamps in a continuous scale by leveraging nonlinear dynamics of event firing trends in each voxel of the 3D predicted voxels. The backbone conversion network comprises a series of training loss function modules, the training loss function modules teaching the backbone conversion network to account for variations in the active pixel sensor video sequence caused by adjustable camera parameters of the active pixel sensor video sequence.

A preferred pose estimation pipeline system includes a source of simulated events with specified poses of an animal, robot or object. a module generates ground truth labels and simulated event streams to create a camera matrix of structural portions of the structural poses. A time-ordered recent event module receives the ground truth labels and the camera matrix and determines a pose mask sequence from the ground truth labels and the camera matrix. The time-ordered recent event module includes a standard time ordering volume creation that provides a first-in-first-out order to each pixel corresponding to polarity of each event and then processes the standard time ordering volume with a neural network configured to predict a series of masks for pose frames, accompanied by quality-assessment scores that are configured to minimize computation costs.

### BRIEF DESCRIPTION OF THE DRAWINGS

FIGS. 1A-1D are a block diagram of a preferred embodiment motion-aware event voxel prediction pipeline and hybrid loss structure;

FIG. 2A-2D illustrate a preferred chain decoupling process used in the FIG. 1 embodiment;

FIG. 3 is a block diagram of a preferred pose estimation pipeline;

FIG. 3A shows a portion of the FIG. 3 pose estimation pipeline;

FIG. 3B shows a portion of the FIG. 3 pose estimation pipeline;

FIG. 4A (Prior Art) shows a process for producing a TORE (Time-ordered recent event) volume; and

FIGS. 4BA and 4BB show a preferred modified process for producing a TORE volume.

### DESCRIPTION OF THE PREFERRED EMBODIMENTS

A preferred embodiment video to event system provides a motion-aware event voxel prediction pipeline and hybrid loss structure with two main stages: a motion-aware event voxel prediction stage and an event sampling stage. The preferred motion-aware event voxel stage includes a learning network, e.g., is a 3D UNet, that encodes input frame pair sequences and generates event frames. The event sampling module is subdivided into chain decoupling and distribution transformation modules, calculates event counts and in-voxel time, then redistributes events in Type 2 voxel, i.e., voxels with a value larger than 1. Loss functions are provided that are tailored for the video-to-event voxel task and are used for training.

The preferred video to event system includes a specialized suite of loss functions tailored for the video-to-event voxel conversion. The system includes a statistics-based local dynamics aware timestamp inference algorithm that enables a smooth transition from event voxels to event streams, which outperforms existing baseline methods. The system uses a set of metrics grounded in DVS event characteristics, allowing for robust quantitative evaluation in both the video-to-event voxel and the voxel-to-event stream phases. Preferred systems ensure that simulated events' count strictly matches ground truth.

A preferred embodiment provides an optimized video-to-event conversion method that can effectively mimic the nonlinear characteristics of a DVS camera with high fidelity to convert APS data.

Preferred embodiments of the invention will now be discussed with respect to experiments and drawings. Broader aspects of the invention will be understood by artisans in view of the general knowledge in the art and the description of the experiments that follows.

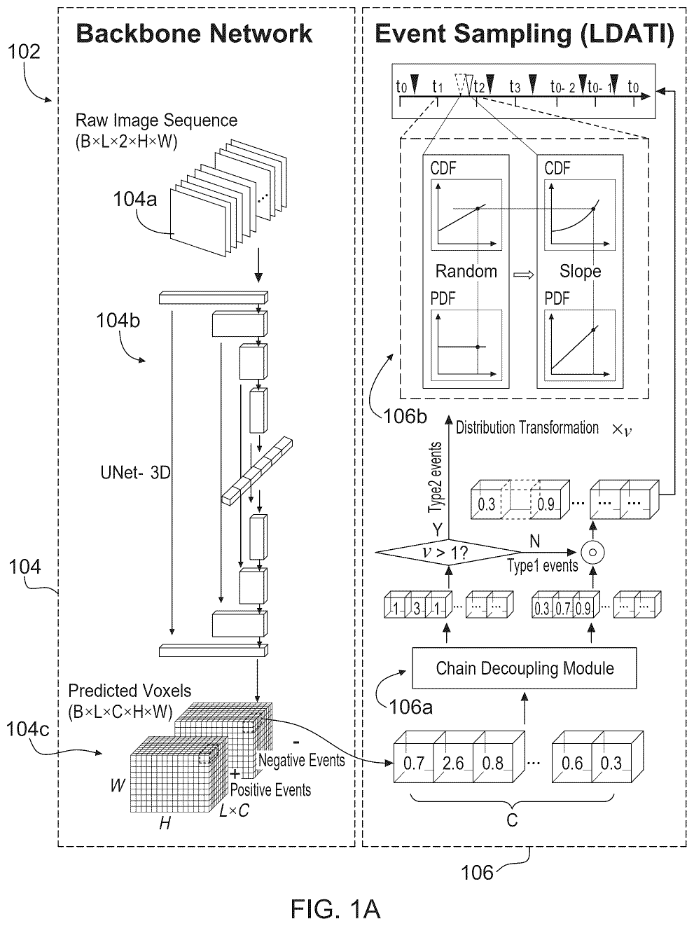

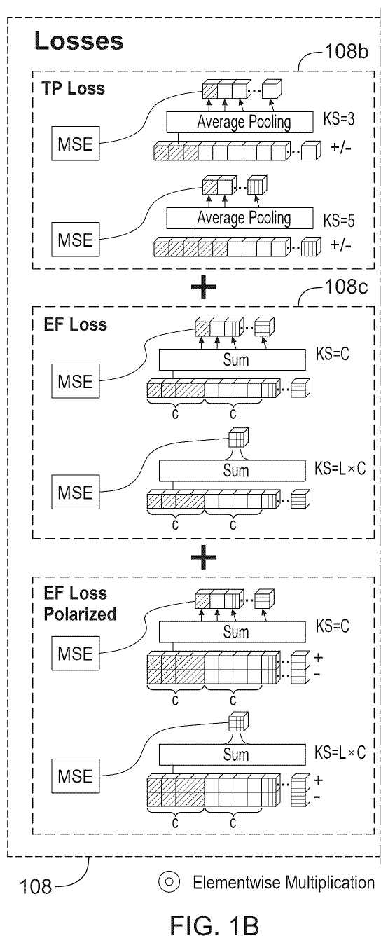

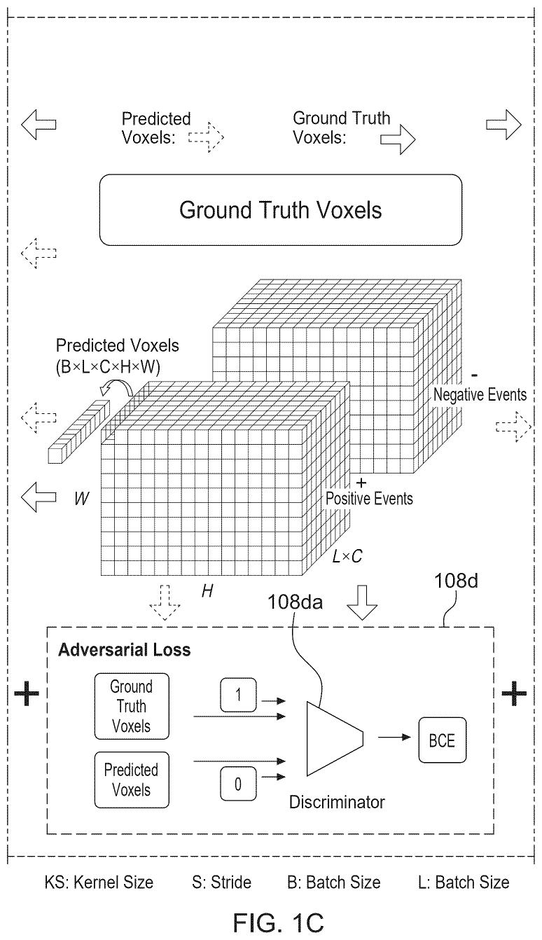

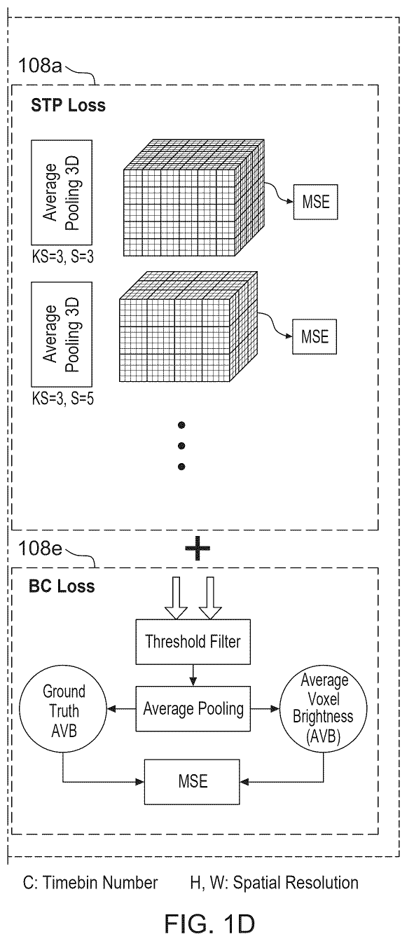

FIGS. 1A-1C are block diagram of a preferred embodiment motion-aware event voxel prediction pipeline and hybrid loss structure 102. A backbone conversion network 104 provides predicted voxels from a raw APS image sequence 104a using a learning network 104b, in this example a 3D UNet, which encodes input frame pair sequences from the image sequence 104a and generates event frames of predicted voxels 104c. An Event Sampling Module 106, subdivided into chain decoupling 106a and distribution transformation 106b modules, calculates event counts and in-voxel time, then redistributes events in Type 2 voxels. Training loss function module 108 develops losses for training the learning network 104b.

The backbone conversion network 104 transforms the APS video sequence 104a into a 3D predicted event voxel cube 104c via the learning network 104b, and the video data is temporally upsampled. The 3D predicted event voxel cube 104c is an (x, y, t) event voxel cube generated from the original event stream. The temporal resolution is increased by a significant margin, e.g., 5 to 10 or more times and the event sequence is represented in a spatio-temporal xyt coordinate system. Each event contains four numbers: (x, y, t, p), where x and y represent the exact spatial coordinate of the corresponding pixel on the image sensor plane; t is the triggering timestamp of this event; and p is the polarity of this event (whether this pixel is getting brighter or dimmer). When turning the event stream into event voxel cube two cubes are constructed based on the polarity of each event, which produces a positive event voxel cube and a negative event voxel cube.

The transformation must preserve the temporal continuity and the microstructure compatibility of event voxels. High-fidelity event voxel reconstruction requires information about nonlinear dynamics of light intensity changes and object movements (e.g., acceleration or higher order moment). While any linear assumption invariably leads to suboptimal video-to-event conversion performance, prior work discussed in the background only used an adjacent frame pair to infer the events between them. Since no hint is available to infer the nonlinear dynamics, such baseline methods essentially conduct linear interpolation between the input APS frame pair.

The transformation conducted by the learning network 104b instead uses longer frame sequences instead of frame pairs to serve as the input of the network. This helps local temporal information flow properly during the inference. A preferred example 3D UNet model was modified to include a sequence of frame pairs, e.g. 16 frame pairs, as the input to the model. The number of frame pairs used will change the time resolution/real flow of the output. Higher numbers of frame pairs can produce better results, in general, but memory limitations and network speed are considerations when increasing the number of frame pairs.

Further complicating the task, event and APS cameras differ in dynamic ranges, which affects information compression in overexposed and underexposed areas. Additionally, both camera types have adjustable parameters such as exposure, ISO sensitivity (standard set by International Organization for Standardization), and aperture, which can be dynamically tuned to adapt to varying environments. This renders the video-to-event voxel prediction a time-varying task, making a straightforward one-to-one mapping between APS video frames and event voxels challenging.

This challenge is met by the training loss function module 108. Denote the input to the model as Iϵ [symbol] ^{(B,L,2,H,W)}, where the five dimensions represent the batch size, sequence length, and spatial resolution. Then, the output event voxels satisfy Vϵ [symbol] ^{(B,L,2×C,H,W)}, where C represents the timebin number between two frames, and the third dimension has a shape of 2×C since events of different polarities are also separated. All submodules in the training loss function module 108 take ground truth voxels and predicted voxels as input.

A first submodule 108a is the Spatial-TemporalPyramid Loss (STP Loss, [symbol] _{STP}). The STP loss module takes the entire concatenated voxel with a shape of (B, L×C, H, W) and applies a series of 3D Average Poolings with varying kernel sizes and strides. This produces more compact representations of both ground truth and predicted event voxels. The STP Loss encourages the model 104b to extract multi-scale information from adjacent voxels, enhancing its robustness against noise by applying coarse supra-voxel matching. Formally, the STP Loss is defined as:

$${ℒ}_{STP} = {\sum }_{k , s ∈ 𝒦 , 𝒮} {w}_{k , s} \cdot {‖ {𝒫}_{k , s}^{3 D} ( {V}_{GT} ) - {𝒫}_{k , s}^{3 D} ( {V}_{pred} ) ‖}_{2}^{2}$$

Where

$${𝒫}_{k , s}^{3 D} ( V )$$

denotes 3D average pooling operation applied to voxel v with a kernel size k and stride s, [symbol] represents the set of all kernel sizes used in the pooling operations, [symbol] represents the set of all strides used in the pooling operations, and w_{k,s} denotes the weights for each combination of kernel size k and stride s.

A second submodule 108b is the Temporal-Pyramid Loss (TP Loss, [symbol] _{TP}), which is designed to encourage the model 104b to prioritize neighboring events, which are crucial for voxellevel event reconstruction. This module applies 1D average pooling along the time axis using varying kernel sizes and strides on both ground truth and predicted event voxels, followed by an L2 loss calculation. Formally, the TP Loss is defined similarly to STP Loss:

$${ℒ}_{STP} = {\sum }_{k , s ∈ 𝒦 , 𝒮} {w}_{k , s} \cdot {‖ {𝒫}_{k , s}^{T} ( {V}_{GT} ) - {𝒫}_{k , s}^{T} ( {V}_{pred} ) ‖}_{2}^{2}$$

Where

$${𝒫}_{k , s}^{T}$$

denotes 1D averavge pooling along the time axis.

A third submodule 108c is the Event Frame Loss (EF Loss, [symbol] _{EF}) that compresses the time axis by summing timebins between adjacent frames or across the entire frame sequence along the time. This addresses the issue of sparsity in voxels and encourages the model 104b to provide better and aligned information flow between generated event frames (aggregation of the predicted voxels 104c on the time axis to transform event voxels into frames with the same framerate as the input APS video) and the input frame sequence 104a. Both polarized and nonpolarized event frames are considered in the loss calculation, which is given by:

$${ℒ}_{EF} = {‖ {𝒮}_{C} ( {V}_{GT} ) - {𝒮}_{C} ( {V}_{pred} ) ‖}_{2}^{2} + {‖ {𝒮}_{LC} ( {V}_{GT} ) - {𝒮}_{L} C ( {V}_{pred} ) ‖}_{2}^{2}$$

Where [symbol] _{C}(·) and [symbol] _{LC}(·) denotes the compression operation that sums over timebins C between adjacent frames and the entire frame sequence LC, respectively.

A fourth submodule 108d is the Adversarial Loss (ADV Loss, [symbol] _{ADV}) that encourages the model 104b to enhance the realness of generated event voxels. Utilizing both ground truth and predicted voxels as real and fake samples respectively, a discriminator 108da is trained for optimal distinction. To prevent [symbol] _{ADV} from becoming unbounded, the generated event voxels strive for high similarity with real voxels to effectively deceive the discriminator.

The relationship between APS frames 104a pixel brightness and the event number between frame pairs is not static, necessitating a dynamic, semantics-based modeling of intrinsic camera parameters. This complexity arises because APS captures brightness as ϕ(I), while DVS records log (ϕ(I)), where I is the scene's absolute brightness and ϕ(I) represents the effect of camera parameters. Given that multiple intrinsic parameters affect, a fixed linear mapping is untenable.

This difficulty is addressed by a fifth submodule 108e, which is BrightnessCompensation Loss (BC Loss, [symbol] _{BC}), which trains the model 104b to compute the average brightness Iₐ of voxels exceeding a threshold β, and align this Iₐ with that of the ground truth voxels. we define the average brightness Iₐ as:

$${I}_{a} ( V ) = \frac{{\sum }_{v ∈ V , v > β} ν}{\vert \{ ν ∈ V : ν > β \} \vert}$$

Where β serves as a threshold to consider voxels that exceed a certain brightness. Given this, the BC Loss between ground truth voxels V_{GT} and predicted voxels V_{pred} is:

$${ℒ}_{BC} = {‖ {I}_{a} ( {V}_{GT} ) - {I}_{a} ( {V}_{pred} ) ‖}_{2}^{2}$$

Losses of the submodules 108a-108e are combined together with a separate weight factor a (which is learned by the model 104b via grid search). The complete loss formula is:

$$ℒ = {α}_{STP} {ℒ}_{STP} + {α}_{TP} {ℒ}_{TP} + {α}_{EF} {ℒ}_{EF} + {α}_{ADV} {ℒ}_{ADV} + {α}_{BC} {ℒ}_{BC}$$

### Event Sampling Module 106

The event sampling module 106 creates exact event timestamps in a continuous scale from output event voxels of the backbone conversion network 104. Leveraging the nonlinear dynamics of the event firing trends in each voxel, the module 106 conducts an advanced sampling technique that is referred to as Local Dynamics-Aware Timestamp Inference (LDATI) for event timestamp recovery. This advanced sampling yields only 3.5% error metric compared to conventional sampling techniques.

Event voxels discretize temporally contiguous events into a dense tensor, suitable for deep learning inference. Rather than merely counting the event numbers in each voxel (with the temporal resolution of δ), the generation of event voxels also preserves the relative temporal information of events within the timebin. Each event influences the voxel series for a predetermined short and finite duration that is the same as each event voxel's timespan, i.e., 1/(10*FPS), where the FPS is the input APS video's frame rate and there are generated 10 voxels per pixel between consecutive video frames, which can be characterized by a continuous-time unit step signal (with an on-time duration same as δ). The value of each voxel is determined by integrating all the step signals for all events within a voxel's designated time range. The sum of all voxels at the same pixel location equals the total number of events occurring within that time frame. This allows the voxel to summarize the total number of events and their relative times with a single number.

Considering the inverse process of event voxel generation, let v be the value of a voxel and v′ be its value after removing the influences of events from the preceding voxel. If only one event is fired in the current voxel, its relative occurrence time within the voxel can be determined by e=[v′]−v′. This event will then exert an e-unit influence on subsequent voxels. Starting from the first voxel, where v=v′, it is possible to iteratively deduce the event count and their relative positions in each voxel.

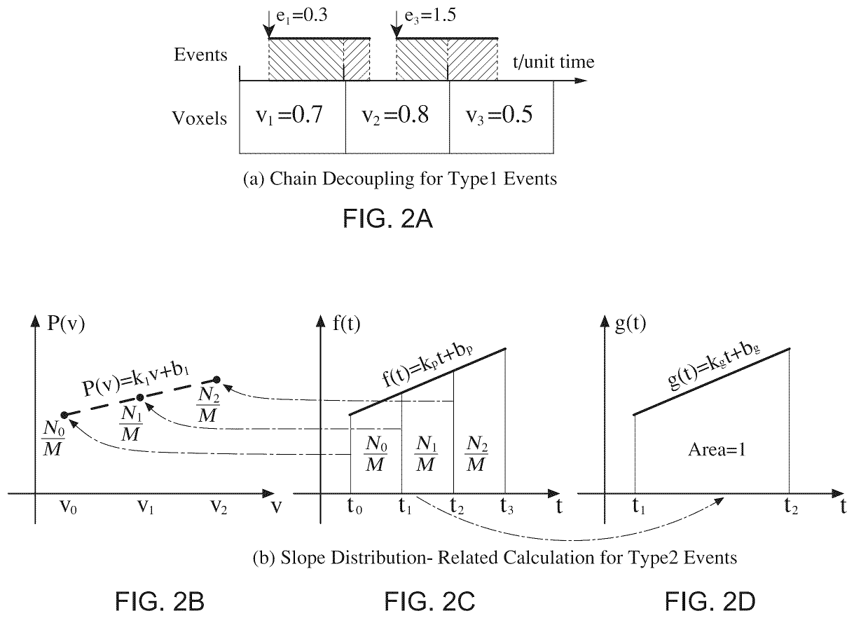

FIG. 2A illustrates a preferred process that is referred to herein as Chain Decoupling. This is a deterministic computation that reconstructs inherent temporal information in the voxels. Voxels are Type 1 if v′≤1 and Type 2 if v′>1.

Event voxels are sparse. Type1 voxels use Chain Decoupling. Type2 voxels require alternatives. Motion and changes happen in a continuous manner and don't change abruptly under natural condition. Thus, if the preceding voxel has a greater value than the succeeding one, events in the intervening voxel are more likely to be biased towards the former, and vice versa.

To accurately model this phenomenon, a preferred process assumes that each voxel and its neighboring voxels conform to a slope distribution described by the Probability Density Function (PDF) f(t)=kₚt+bₚ. Given that the event timestamp distribution within a voxel is primarily influenced by its temporal neighbors, a simpler slope distribution suffices for both accuracy and computational efficiency. This PDF allows estimation of event timestamps while accounting for local dynamics, outperforming random sampling approaches.

Let the voxel value in three adjacent voxels be denoted as N₀, N₁, and N₂, and their sum as M. The objective is to derive the expression for their PDF f (t) using these known variables. If g(t) represents the PDF of the event timestamp distribution conditional on t being in the central voxel v₁, then:

$$g ( t ) = {f}_{T \vert V} ( t \vert v ) = \frac{{f}_{T , V} ( t , v )}{P ( V = v )} = \frac{f ( t )}{P ( V = v )}$$

In this formulation, T and V denote the exact event timestamp and its corresponding timebin, respectively.

FIGS. 2B-2D visually illustrate the relationship among f(t), g(t), and P(v). P(v) also follows a linear formula with a slope kₛ=δkₚ=δk_{g}. Given

$${k}_{s} = \frac{{N}_{2} - {N}_{0}}{2 δ M} ,$$

the expression for g(t) can be derived accordingly.

$$g ( t ) = {k}_{p} t + 1 / δ - δ {k}_{p} / 2$$

where

$${k}_{p} = \frac{{N}_{2} - {N}_{0}}{2 {δ}^{2} M} .$$

While g(t)-based sampling could be applied individually on each voxel, this would be computationally expensive due to varying distribution formulas and event numbers. The process can be optimized through the distribution transformation. By initially sampling from a uniform distribution with PDF γ(u)=1/δ, and then converting it to the desired slope distribution via matrix operations, the sampling process is greatly accelerated. This conversion can be achieved using the inverse cumulative distribution function (CDF) method as follows:

$$t = ( - {b}_{p} + \sqrt{{b}_{p}^{2} + 2 {k}_{p} u} ) / {k}_{p}$$

### Experimental FIG. 1 Pipeline

An experimental example motion-aware event voxel prediction pipeline and hybrid loss structure consistent with FIG. 1, once trained, generated 10 voxels per pixel between consecutive grayscale video frames at 30 fps. This effectively maps each frame with dimensions H×W to an event voxel of dimensions (2×10)×H×W. Upon evaluation with the entire MVSEC dataset, we found this ten-fold upscaling to be adequate. Specifically, only approximately 2.30% of the voxels are non-zero, and among these, a mere 6.66% exceed one. This validates that partitioning the time range between two frames into 10 timebins is sufficient for capturing the event stream.

The experimental pipeline was shown in experiments to be able to reconstruct events generated in the saturated light area that methods discussed in the background were not able to reconstruct. Qualitative and quantitative analyses showed that the present method provided predicted event frames that are loyal to actual brightness, whereas prior methods tend to generate non-existent events with unmatched details. The present methods perform better in under and overexposed portions of scenes.

The experimental neural network was trained using the Adam optimizer, setting the learning rate to 0.001 and running the training for 100 epochs on our dataset. This project is built on top of PyTorch Lighting. Experiments used the Multi Vehicle Stereo Event Camera (MVSEC) dataset [Zhu, et al, “The multivehicle stereo event camera dataset: An event camera dataset for 3d perception,” IEEE Robotics and Automation Letters, vol. 3, no. 3, pp. 2032-2039, 2018], which is one of the largest and most commonly used datasets for DVS-based research. The dataset was randomly partitioned into training, validation, and testing subsets, following an 80%/10%/10% distribution. Each data entry in the dataset comprises 17 sequential grayscale frames, along with the associated 16 event packets in between. The experimental model 104 is 52.9 MB, and it requires 779.17 GFlops to perform inference on a single image pair sequence. Each sequence has a length of 16, which corresponds to 0.53 seconds of video length when the video's frame rate is 30 Hz. When evaluated on an A10 graphics card, the model's average inference time for a 16-pairs sequence was 312.83 milliseconds, and the corresponding sampling time in module 106 was 106.97 m. This allows us to generate events from approximately 39 frames per second, meeting the criteria for real-time performance.

### Pose Estimation Pipeline

Pose estimation, for example the dance pose estimation of human subjects provide special challenges compared to gesture recognition-level daily actions because of a greater diversity of movements. Event based cameras face special challenges in the context of pose estimation, because of their inherent high-frequency and motion-sensitive nature. In noisy and dynamic environments, 3xtreme motion sensitivity can result in numerous events from environmental signals rather than actual poses of a subject, such as a dancer, which can create a severe event filtering problem.

A preferred pose estimation pipeline provides an early-exit-style event filtering mechanism that predicts a binary mask over the posing subject and rejects events not generated to movement of the subject. The preferred pipeline also preserves the entire subject, which may have portions that pose quickly and other portions that move little, such as the arms of a dancer as compared to the body of the dancer. A spatiotemporal representation is provided that can compile information derived from an event stream, preserve historical data, and eliminate noise events. Information flow between frames is preserved in the preferred embodiment. Neighboring frames exhibit similarities in historical information, such as human joint locations of a dancer. By considering feature maps of these frames as a time series and employing a temporal method to facilitate information flow between frames, the pipeline gathers information regarding missing slowly movement portions, e.g., a torso, and generates more persuasive joint location estimates.

The preferred pose estimation pipeline provides a Time Ordered Recent Event (TORE) volume representation that concurrently preserves both the most recent and relevant historical information, thereby helping alleviate the missing portion issue. This representation also functions as a noise filter for noise types without impacting other significant signals.

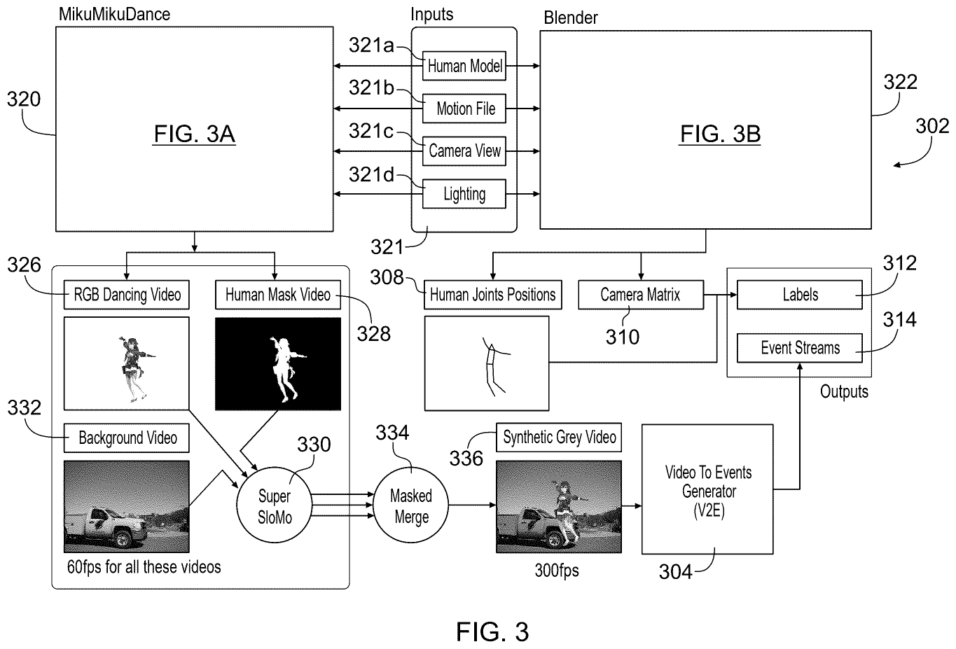

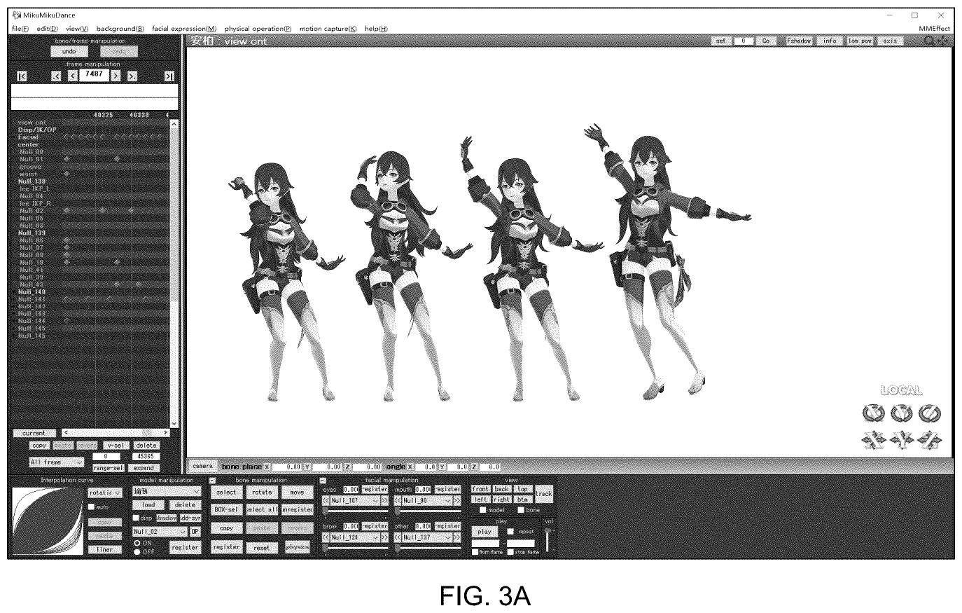

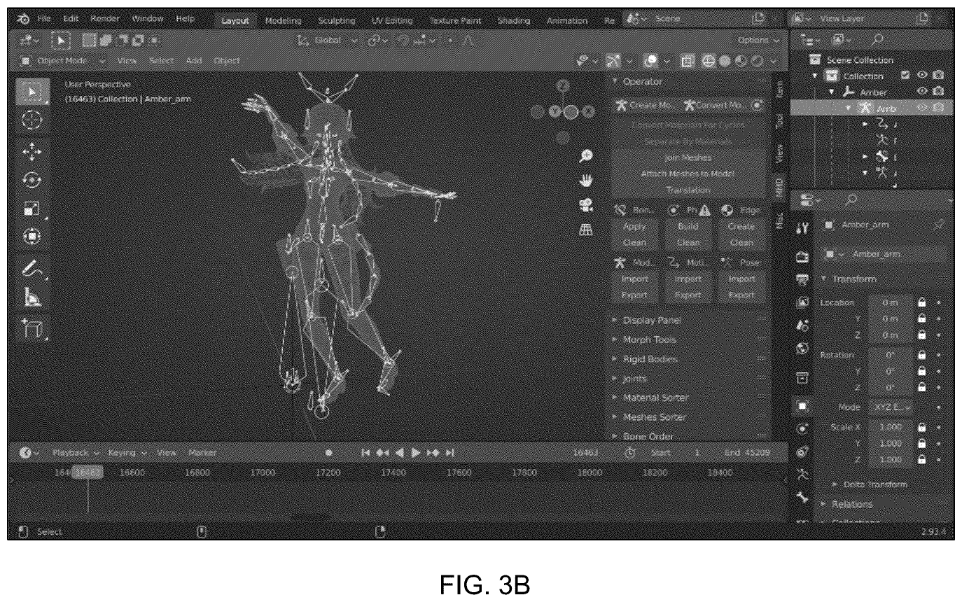

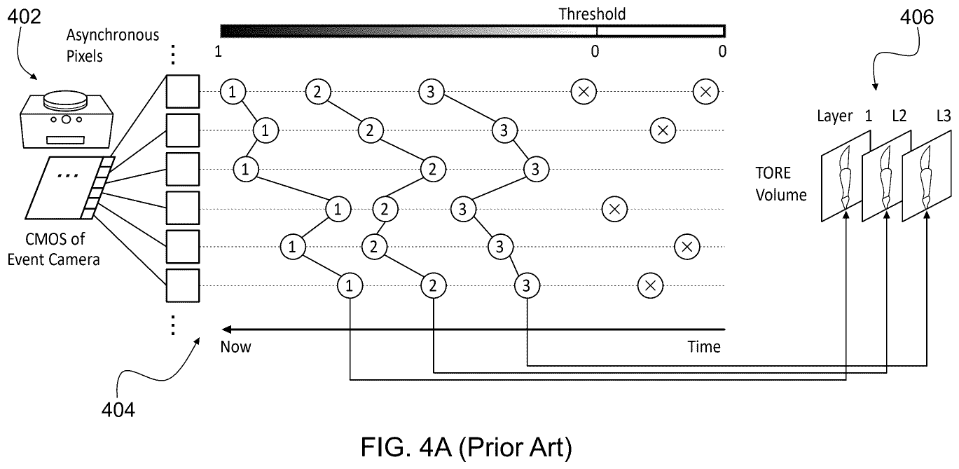

FIGS. 3, 3A and 3B show a preferred pose estimation pipeline 302. It is applied by way of example to human dance pose estimation, but is generally applicable to pose estimation of a natural or artificial body that includes difficult to predict poses. The pipeline 302 includes synthetic data generation utilizing with a comprehensive motion-to-event simulator that uses motion files, human models, camera views, lighting, and other settings as input. These inputs are rendered into RGB and human mask videos in MMD (MikuMikuDance Freeware), subsequently merged with background videos.

After the RGB video rendering, merged videos are sent to the V2E events stream generator 304. Many parameters, such as event trigger thresholds, noise level, and slow-motion interpolation scale, can be set as predetermined values and updated manually in in the V2E generator 304. These features enable the pipeline 302 to generate many highly customizable DVS event streams at a meager cost in a short time. To simulate situations in the real world, we increase the noise as the brightness decreases.

For human joints' ground truth determination, customized scripts automatically loop through all pose timestamps with a configured fixed FPS and in each iteration record the exact millimeter-level 3D location for each specified human joint and inject them into the Blender module 322 (described further below) to collect the exact 3D location 308 of all joints while rendering scenes at 300 FPS. Scripts help extract the camera's intrinsic and extrinsic matrix 310 used in label pre-processing 312. These scripts, for a given camera configuration inside the software Blender 322, compute and record the camera intrinsic & extrinsic matrix based on the accessible inner variables in Blender 322. 3D human models have even more initial flexibility than actual footage, including skin color, height, body style, clothing, hair color, style, and accessories, which are all easily modifiable—which is very difficult to do in realworld data collection.

Inputs 321 including human model 321a, motion file 321b, camera view 321c and lighting configuration 321d are loaded and configured in MMD and Blender (Blender Video Editor) in the corresponding option panels during the simulation. Rendering is done in MMD, and a human APS video 326 as well as a corresponding human mask video 328 are generated simultaneously. The human mask video can serve as a guidance during a merging 334 of human APS video and a background video 332 by point-wise multiplication of the corresponding mask frame in the mask video 328 and the human video 326, and point-wise multiplication of the 0-1 reversed mask frame and the background video. The finalized APS video is made of the summation of the two resulting frames during a masked merge 334 to produce synthetic video 336. The generator 304 combines these rendered dance videos with collected background videos to generate both data event stream 314 and paired labels 312 at the same time. If a video's temporal resolution is low, and FIG. 1 is not applied, the generated event stream can be less realistic. In experiments, due to software limitations and background video quality, the synthesized videos are at 60 FPS. This gap in FPS is realistically compensated by FIG. 1 when converted to event stream directly, but can also be compensated with other tools to keep the modality conversion for later, such as SuperSlowMo 330 [H. Jiang, et al., “Super slomo: High quality estimation of multiple intermediate frames for video interpolation,” Proceedings of the IEEE conference on computer vision and pattern recognition, pp. 9000-9008 (2018)], which can interpolate videos to a high FPS. To reduce the time and computation cost, FIG. 3 only applies SuperSlowMo 330 to dance and background videos before the merging 334, which avoids a need to interpolate synthesized videos for each human and background combination.

### Event Preprocessing and Modified TORE Volume

In contrast to the original TORE volume, Baldwin, et al, “Time-ordered recent event (tore) volumes for event cameras,” ArXiv abs/2103.06108 (2021), the present embodiment provides a modified TORE volume through a normalization, 0-1 flip, and range scaling.

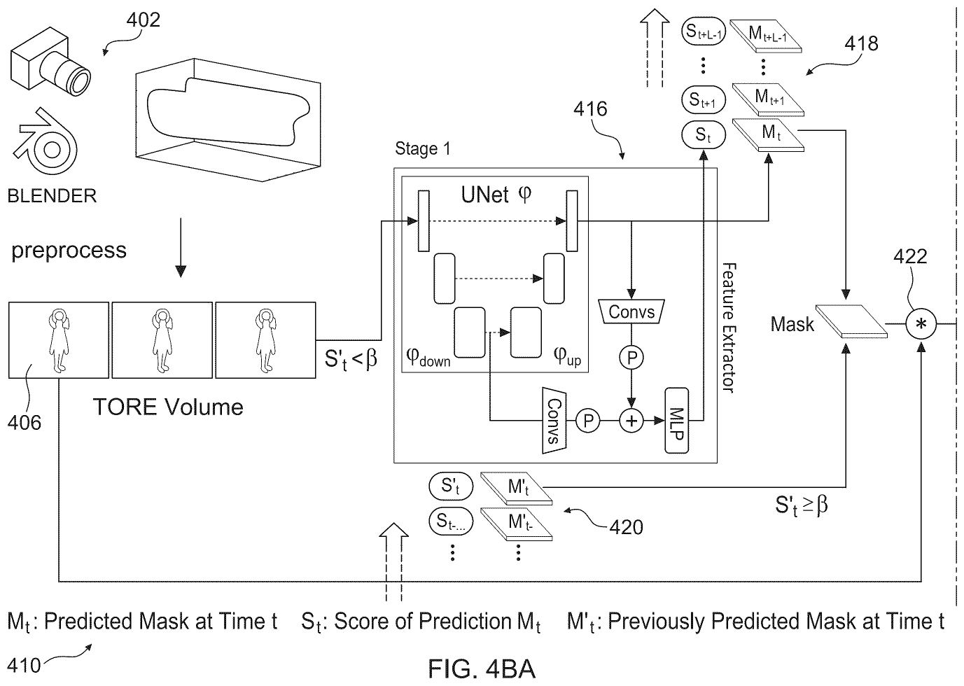

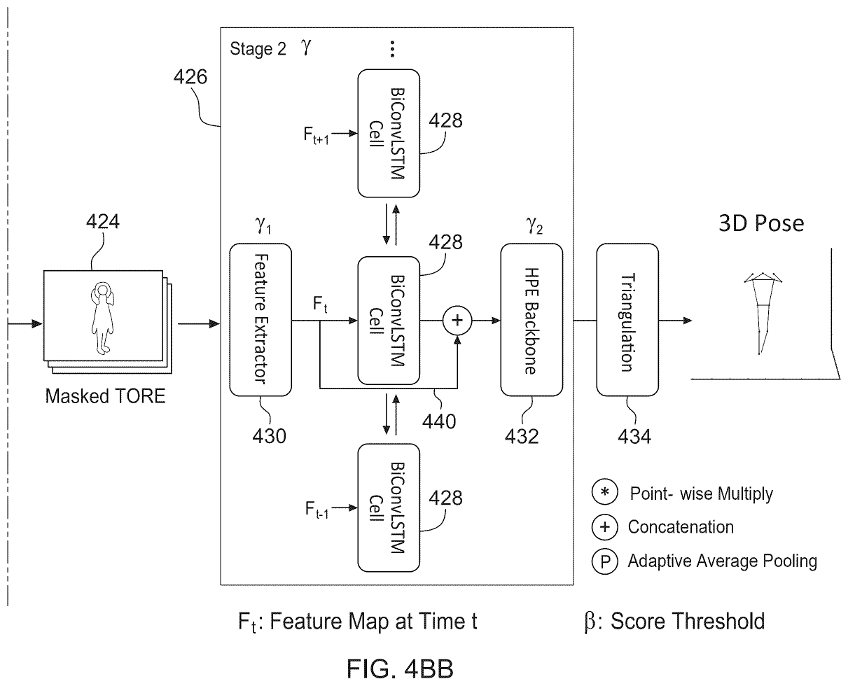

FIG. 4A (Prior Art) shows a process for producing a TORE volume and FIGS. 4BA and 4BB the modified TORE volume processing of the preferred embodiment. FIGS. 4BA and 4BB provide a transformation process that converts input events into TORE volumes. FIG. 3 generates the raw event stream, while FIGS. 4BA and 4BB transform the event stream into dense representation TORE volumes. In FIG. 4A, each pixel in a neuromorphic (even) 402 camera operates asynchronously, and a First-In-First-Out (FIFO) queue 404 is provided for each pixel corresponding to each event polarity (polarity denotes whether the event is triggered by an increase or decrease in brightness). The queue 404 possesses a depth of K (here K=3), and when a queue becomes full and subsequent events arrive, the oldest event is removed from the queue. The i^{th} layer 406 of TORE is produced by extracting the i^{th} event stored in the FIFO queues of all pixels.

FIGS. 4BA and 4BB shows the preferred modified TORE pipeline 410. The standard TORE volume 406 is processed by a neural network 416, which is a stage one human body mask prediction network. This network predicts a series of masks 418 for the ensuing frames, accompanied by quality-assessment scores 420 to minimize computation costs. The estimated human mask undergoes point-wise multiplication 422 with the original TORE volume 406 to produce a modified TORE volume 424 before advancing to a human pose estimation network 426, where BiConvLSTM 428 (a bidirectional recurrent neural network discussed further below) is between a feature extractor 430 and a HPE backbone 432 that provides three hourglass-like refinement blocks, which are employed to estimate the heatmap of joints' projections on three orthogonal planes. The precise 3D coordinates of these joints are determined through a triangulation process 434 based on these heatmaps.

Event Filtering with Human Body Mask Prediction Network 416

To filter out events triggered by background activities and neuromorphic camera hardware noise (e.g., hot pixel and leak noise), the mask prediction network 416 is employed, capable of predicting a human body mask from the TORE volume representation 406.

The mask prediction network 416 is a modified version of the U-Net in Ronneberger et al., “U-net: Convolutional networks for biomedical image segmentation, in: International Conference on Medical image computing and computer-assisted intervention,” Springer, pp. 234-241 (2015). The modified network 416 can predict the mask for the current input frame and a series of masks following this frame. Each predicted mask is generated in conjunction with a confidence score. The primary rationale behind predicting the human body mask of future frames is that future motion trajectories of different human body parts are generally predictable with information about current and previous motion trajectories.

TORE volume representation efficiently captures current and previous motion history, which enables the mask prediction network 416 to estimate human body masks of the current and future frames and their corresponding confidence scores. The confidence scores offer an early-exit-like mechanism, allowing the computational pipeline to bypass mask prediction for a specific frame if the mask predicted based on a previous frame's TORE volume achieves a high confidence score, which significantly reduces the computational cost and energy consumption. For the predicted mask, the U-Net 416 generates floating point numbers between 0 and 1, with a binarization process employing a minimal threshold of 0.1. The small threshold ensures that the generated mask does not exclude any parts of the human body, as failure to encompass the entirety would result in greater error than permitting a slight amount of noise.

Denote the input TORE representation 406 as Xₜ, and the U-Net 416 as φ, with the first half denoted as φ_{down} and the latter half as φᵤₚ. Then, apply:

$$φ ( {X}_{t} ) = \{ \begin{matrix}{M}_{t}^{′} , & {S}_{t}^{′} exists \& {S}_{t}^{′} ⩾ β \\ [ {M}_{t} , {M}_{t + 1} , ⋯ , {M}_{t + L - 1} ] , & Otherwise\end{matrix}$$

where Mₜ represents the predicted human mask at timestamp t, and M_{t′} signifies the human mask of this timestamp previously predicted. The confidence scores of Mₜ and Mₜ/are denoted as Sₜ and Sₜ, respectively, where:

$$[ {S}_{t} , ⋯ , {S}_{t + L - 1} ] = MLP [ P [ {Conv}_{1} [ {φ}_{down} ( {X}_{t} ) ] + P [ {Conv}_{2} [ φ ( {X}_{t} ) ] ] ]$$

when the corresponding Sₜ does not exist. Here, P represents adaptive pooling layers, Conv denotes convolutional layers, and MLP signifies a multi-layer perceptron.

A significant challenge in training the mask prediction network with an end-to-end approach is the absence of a realistic neuromorphic camera dataset containing labeled human body mask sequences for recorded event streams. However, the pipeline 302 includes a motion to event simulator 304 that can generate paired pixel-level human masks at a high frame rate, which can be utilized to comprehensively train the mask prediction network. In addition, the motion to event simulator 304 can be replaced with the continuous motion to event simulator 102 of FIGS. 1A-1C.

### Human Pose Estimation Network 426

This network includes the ResNet-based feature extractor 430, the Bidirectional Convolutional LSTM (BiConvLSTM) layer 428, the HPE backbone 432, and the triangulation module 434. The initial portion of ResNet34 functions as the feature extractor, succeeded by the BiConvLSTM layer 428 incorporating a skip connection 440. Given that the human body undergoes no abrupt changes within a relatively brief temporal window, adjacent frames typically exhibit similar ground truth labels. This continuity in human joint movements renders it advantageous to reference neighboring frames when estimating joint positions.

BiConvLSTM 428 represents a bidirectional variant of ConvLSTM [Shi, et al, “Convolutional lstm network: A machine learning approach for precipitation nowcasting,” Advances in neural information processing systems 28 (2015)], in which ConvLSTM constitutes a form of recurrent neural network designed for spatiotemporal prediction, incorporating convolutional structures within both input-to-state and state-to-state transitions. Subsequently, the HPE backbone 432 includes three hourglass-like CNN (Convolutional Neural Network) blocks, each producing a series of marginal heatmaps to reconstruct the coordinates of human joints in 3D space. All intermediate outputs from these three blocks are utilized to compute the loss with the ground truth heatmaps, while the final two blocks can be regarded as refinement networks. The feature extractor and backbone network architecture have been developed based on a model described in Scarpellini et al, “Lifting monocular events to 3d human poses,” in: Proceedings of the IEEE/CVF Conference on Computer Vision and Pattern Recognition, pp. 1358-1368 (2021). Denoting the feature extractor as γ₁ and the generated feature map as Fₜ, define

$${F}_{t} = {γ}_{1} ( {X}_{t} \cdot {M}_{t} )$$

in which the multiplication is a pixel-wise multiplication. Consequently, the generated joint heatmaps Hₜ can be derived as follows:

$${H}_{t} = {γ}_{2} [ Con v [ BiConvLSTM ( {F}_{t} ) , {F}_{t} ] ]$$

For each joint, the Network 416 generates three heatmaps depicting the probability of its projected position on the xy, xz, and yz planes (denoted as

$${H}_{t}^{xy} , {H}_{t}^{xz} , {H}_{t}^{yz} ) .$$

Subsequently, a soft-argmax operator is applied to extract the normalized coordinates of the joint. Ultimately, predictions from the xy plane serve as the final estimations for x and y coordinates, while values for z are computed by averaging the yz and xz predictions. The formula can be expressed as follows:

$$[ {x}_{tj}^{xy} , {y}_{tj}^{xy} ] = σ ( {H}_{tj}^{xy} )$$

$$[ {x}_{tj}^{xz} , {z}_{tj}^{xz} ] = σ ( {H}_{tj}^{xz} )$$

$$[ {y}_{tj}^{yz} , {z}_{tj}^{yz} ] = σ ( {H}_{tj}^{yz} )$$

$${p}_{tj}^{xyz} = ⌈ {x}_{tj}^{xy} , {y}_{tj}^{xy} , \frac{{z}_{tj}^{yz} + {z}_{tj}^{xz}}{2} ⌉$$

where

$${x}_{t}^{xy}$$

denotes the estimated x at time t for a specific joint j's predicted xy-plane heatmap, σ means the soft-argmax operator, and p_{xyz} represents the predicted 3D coordinates for joint j at time t.

The ground truth labels employed during training and testing are normalized prior to being input into the network 416. For a particular joint, the network 416 initially projects it onto a plane parallel to the camera's image plane, maintaining the same depth as the depth reference. The head joint's depth value serves as this reference. Subsequently, the 3D space within the DVS camera's view is mapped to a cube with a range of [−1,1]. Finally, as the network does not directly predict the 3D coordinates of a joint but instead forecasts its marginal heatmaps, it extracts the joints' projections on three orthogonal faces of a normalized space cube to generate the ground truth for marginal heatmaps. The ultimate marginal heatmaps are computed using a Gaussian filter applied to these projection images.

### Loss in the Mask Prediction Network 416

The network loss function includes three components. The initial component is the Binary Cross Entropy (BCE) loss, computed between the predicted mask series M and the corresponding ground truth masks M. This loss is implemented to ensure the precision of all generated masks. Subsequently, a Mean Square Error (MSE) loss is calculated over the predicted confidence scores S and their ground truth. The ground truth score represents the Mean Absolute Error (MAE) between a predicted mask and its respective ground truth mask. Finally, although the objective is to predict the mask series for the current frame and subsequent frames, they are not uniformly significant. It is imperative to ensure that masks for proximate frames receive greater weighting, particularly for the current frame. Consequently, an additional BCE loss is computed between the predicted mask for the current frame (\hat{M}₀) and its corresponding ground truth M₀. The cumulative loss is:

$${Loss}_{mask} = BCE ( M , \hat{M} ) + BCE ( {M}_{0} , {\hat{M}}_{0} ) + MSE ( S , MAE ( M , \hat{M} ) )$$

The loss presented in [Scarpellini, et al., “Lifting monocular events to 3d human poses,” Proceedings of the IEEE/CVF Conference on Computer Vision and Pattern Recognition, pp. 1358-1368 (2021)] was used for the human pose estimation network. As the marginal heatmaps can be interpreted as probability distributions of joint locations, Jensen-Shannon Divergence (JSD) can be applied between the predicted heatmaps by each block (Ĥⁱ, where i denotes the block index) and the ground truth heatmaps H on each projection plane (xy, xz, zy). Additionally, a geometrical loss is computed between the reconstructed 3D joint coordinates \hat{p}xyz and their ground truth pxyz. The loss for this stage can be expressed as follows:

$${LoSS}_{HPE} = {\sum }_{i} ( {‖ {\hat{p}}_{xyz}^{i} - {P}_{xyz} ‖}_{2} + JSD ( {H}_{xy} , {\hat{H}}_{xy} ) + JSD ( {H}_{xz} , {\hat{H}}_{xz} ) + JSD ( {H}_{zy} , {\hat{H}}_{zy} ) )$$

Tools used in preferred pose estimation pipeline 302 of FIG. 3

The pipeline 302 used some available tools for generating synthetic data with a comprehensive motion-to-event simulator. Synthetic data generation consists of RGB dance video rendering via MikuMikuDance (MMD) 320, human joints' position extraction via Blender 322, and events generation and events generation via the V2E 304.

MMD 320 is a freeware animation program that lets users animate and creates 3D animated movies. This software is simple but powerful, with a long history and a big open-source community supporting it. Many human models, scenes, and movement data can be easily accessed for free. In addition, it can automatically handle clothing physics and interaction with the body in a sophisticated manner with minimal manual adjustment.

Blender 322 can generate human joints' ground truth labels and camera matrix. Blender is a free and open-source 3D computer graphics software for creating animated films, motion graphics, etc. It is highly customizable, and all essential information can be accessed during rendering, including the 6 degrees of freedom coordinates of human joints and the camera center. The 13 key points' ground truth coordinates are extracted at 300 frames per second (FPS).

Video to Event (V2E) 304 is used for event generation. V2E is a toolset released in 2021 by Delbruck et al. [“v2e: From video frames to realistic DVS events,” 2021 IEEE/CVF Conference on Computer Vision and Pattern Recognition Workshops (CVPRW), IEEE, 2021]. It can synthesize realistic event data from any conventional frame-based video using an accurate pixel model that mimics the neuromorphic camera's nonidealities. According to its author, V2E supports an extensive range of customizable parameters and is currently the only tool to model neuromorphic cameras realistically under low illumination conditions. More preferably, FIGS. 1A-1C are used to provide a V2E function.

While specific embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the appended claims.

1. A video to event prediction pipeline system, comprising:
a backbone conversion network having a model that is configured to receive a raw active pixel sensor video sequence and convert it into 3D predicted voxels;
an event sampling module configured to receive the 3D predicted voxels and create event timestamps in a continuous scale by leveraging nonlinear dynamics of event firing trends in each voxel of the 3D predicted voxels; wherein
the backbone conversion network comprises a series of training loss function modules, the training loss function modules teaching the backbone conversion network to account for variations in the active pixel sensor video sequence caused by adjustable camera parameters of the active pixel sensor video sequence.

2. The video to event prediction pipeline system of claim 1, wherein the adjustable camera parameters comprise one or more of exposure, ISO, and aperture.

3. The video to event prediction pipeline system of claim 1, wherein the training loss function module comprises a loss module that encourages the model to extract multi-scale information from adjacent voxels by applying coarse supra-voxel matching.

4. The video to event prediction pipeline system of claim 3, wherein the training loss function module comprises a loss module that encourages the model to prioritize neighboring events.

5. The video to event prediction pipeline system of claim 4, wherein the training loss function module comprises a loss module that encourages the model to align information flow between the predicted event frames and the active pixel sensor video sequence.

6. The video to event prediction pipeline system of claim 5, wherein the training loss function module comprises a loss module that encourages the model to enhance realness of the predicted 3D event based voxels by training a discriminator using ground truth and predicted voxels and real and fake samples.

7. The video to event prediction pipeline system of claim 6, wherein the training loss function module comprises a loss module that encourages the model to compute average brightness of voxels exceeding a threshold and align with brightness of ground truth voxels.

8. The video to event prediction pipeline system of claim 7, wherein the event sampling module ensures that each event influences a voxel series only for a predetermined duration.

9. The video to event prediction pipeline system of claim 1, wherein the event sampling module ensures that each event influences a voxel series only for a predetermined duration.

10. The video to event prediction pipeline system of claim 1, wherein the event sampling module assumes that each voxel of the 3D predicted voxels conforms to a slope distribution described by a probability density function.

11. A pose estimation pipeline system, comprising:
a source of simulated events with specified poses of an animal, robot or object;
a module to generate ground truth labels and simulated event streams to create a camera matrix of structural portions of the structural poses; and
a time-ordered recent event module receiving the ground truth labels and the camera matrix and determining a pose mask sequence from the ground truth labels and the camera matrix, wherein the time-ordered recent event module comprises a standard time ordering volume creation that provides a first-in-first-out order to each pixel corresponding to polarity of each event and then processes the standard time ordering volume with a neural network configured to predict a series of masks for pose frames, accompanied by quality-assessment scores that are configured to minimize computation costs.

12. The pose estimation pipeline system of claim 11, wherein the neural network conducts a bidirectional recurrent operation and includes hourglass-like refinement blocks configured to estimate a heatmap of the structural portions projected on three orthogonal planes.

13. The pose estimation pipeline system of claim 12, wherein the neural network determines 3D coordinates of the structural portions by a triangulation process on the heatmap.

14. The pose estimation pipeline of claim 12, wherein the simulated poses are human poses and the structural elements are human joints.
